(19) United States
(12) Patent Application Publication
(10) Pub. No.: US 2025/0371440 A1
(43) Pub. Date: Dec. 4, 2025

(54) ASYNCHRONOUS GENERATION OF PROVISIONING DATA STRUCTURES AND PROVISIONING TASKS

(71) Applicant: Veho Tech, Inc., Claymont, DE (US)

(72) Inventors: Azeem Ahmed, Irving, TX (US); Joshua James Hanna, Centerton, AR (US); James Edward Logue, Denver, CO (US); Jean-Michel Stanislas Michno, Minnetonka, MN (US); Varun Gupta, Brooklyn, NY (US); Edwin Ruben Maurice Antoine Lohmann, Medford, MA (US)

(73) Assignee: Veho Tech, Inc., Claymont, DE (US)

(21) Appl. No.: 19/225,826

(22) Filed: Jun. 2, 2025

Related U.S. Application Data
(60) Provisional application No. 63/655,567, filed on Jun. 3, 2024.

(51) Int. Cl. G06N 20/20

(52) U.S. Cl. CPC G06N 20/20

(57) ABSTRACT

A system includes a first machine-learning model executed using as input predicted package data to generate a set of provisioning data structures each comprising a predicted region, a predicted duration, and a value, a second machine-learning model executed using as input actual package data to generate a set of routes of provisioning tasks, and a third machine-learning model executed using as input the set of provisioning data structures generated by the first machine-learning model and the set of routes of provisioning tasks generated by the second machine-learning model to generate pairings of provisioning data structures and routes of provisioning tasks.

### CROSS-REFERENCE TO RELATED APPLICATIONS

This application claims priority to U.S. Provisional Application No. 63/655,567, filed Jun. 3, 2024, which application is incorporated herein by reference.

### BACKGROUND

Coordinating package delivery of variable numbers of packages having varying delivery destinations is a complex, time-sensitive task. Conventional solutions call for manual determination of delivery routes and manual assignment of packages to drivers and delivery routes.

### SUMMARY

Various aspects of the disclosure may now be described with regard to certain examples and embodiments, which are intended to illustrate but not limit the disclosure. Although the examples and embodiments described herein may focus on, for the purpose of illustration, specific systems and processes, one of skill in the art may appreciate the examples are illustrative only, and are not intended to be limiting.

Last-mile package delivery calls for receiving packages from a variety of sources and delivering the packages to a large number of various addresses. Significant uncertainty exists in how many packages will be received, how many drivers are needed, and where those drivers will go to deliver packages. It may be stressful for drivers to not know ahead of time whether they are needed for deliveries. This may be especially difficult for contract drivers who are paid according to the deliveries they accomplish. Conversely, package delivery coordination solutions may grapple with uncertainty around the availability of delivery drivers in a specific region on a specific day. The present disclosure addresses these problems by providing a collection of interconnected machine-learning models which independently generate driver-facing offers, package delivery route plans and pairings of the driver-facing offers and package delivery route plans. By generating offers based on predicted package data independent of route plans generated based on actual package data, offers can be presented to drivers and accepted well in advance of delivery deadlines. Then, accepted offers and route plans can be paired to allocate actual packages and an actual delivery route to the accepted offers. The offers, route plans, and pairings can be dynamically generated and updated throughout the process to optimize the offers, route plans, and pairings. In this way, greater flexibility and optimization is introduced into the coordination of package delivery while also providing greater predictability to drivers and delivery coordination solution providers.

The foregoing summary is illustrative only and is not intended to be in any way limiting. In addition to the illustrative aspects, embodiments, and features described above, further aspects, embodiments, and features may become apparent by reference to the following drawings and the detailed description.

### BRIEF DESCRIPTION OF THE DRAWINGS

FIG. 1 is a block diagram of an example system for coordinating package delivery.

FIG. 2 is an example timeline for coordinating package delivery.

FIG. 3 is a flow diagram of an example method for coordinating package delivery.

The foregoing and other features of the present disclosure may become apparent from the following description and appended claims, taken in conjunction with the accompanying drawings. Understanding that these drawings depict only several embodiments in accordance with the disclosure and are therefore, not to be considered limiting of its scope, the disclosure may be described with additional specificity and detail through use of the accompanying drawings.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It may be readily understood that the aspects of the present disclosure, as generally described herein, and illustrated in the figures, may be arranged, substituted, combined, and designed in a wide variety of different configurations, all of which are explicitly contemplated and made part of this disclosure.

Package delivery coordination systems can involve managing the distribution of packages from various sources to multiple destinations. Such systems can require processing large volumes of data related to package characteristics, delivery locations, and driver availability. Delivery coordination can encompass tasks such as route planning, driver assignment, and package sorting. The complexity of these tasks can increase with the number of packages, diversity of delivery locations, and variability in driver schedules.

Conventional package delivery coordination systems can face challenges in efficiently matching drivers to delivery routes and packages. These systems can struggle to account for fluctuations in package volume and driver availability, leading to suboptimal route assignments and inefficient resource allocation. Additionally, traditional approaches can lack the ability to adapt quickly to changing conditions or to provide drivers with advance notice of potential work opportunities.

The techniques described herein can address these challenges by implementing a multi-model machine learning approach to package delivery coordination. This approach can utilize separate machine learning models for generating driver offers, creating route plans, and pairing offers with routes. By leveraging predicted package data, the system can generate driver offers in advance of actual package data availability, allowing for earlier driver engagement and improved planning.

In some implementations, a first machine learning model can generate driver-facing offers based on predicted package data. These offers can include information such as potential delivery regions, estimated package counts, and projected durations. A second machine learning model can create route plans using actual package data as it becomes available. A third machine learning model can then pair the generated offers with the created route plans, optimizing the allocation of packages and routes to accepted driver offers. The system can continuously update and refine these offers, route plans, and pairings as new data becomes available, adapting to changing conditions in real-time.

The techniques described herein can provide several technical improvements over existing approaches. By decoupling offer generation from route planning, the system can engage drivers earlier in the process, improving driver availability and satisfaction. The use of machine learning models for each component of the coordination process can enable more efficient and adaptive decision-making compared to manual or rule-based systems. Additionally, the continuous updating of offers, routes, and pairings can allow for dynamic optimization of package delivery coordination, potentially reducing delivery times and improving resource utilization.

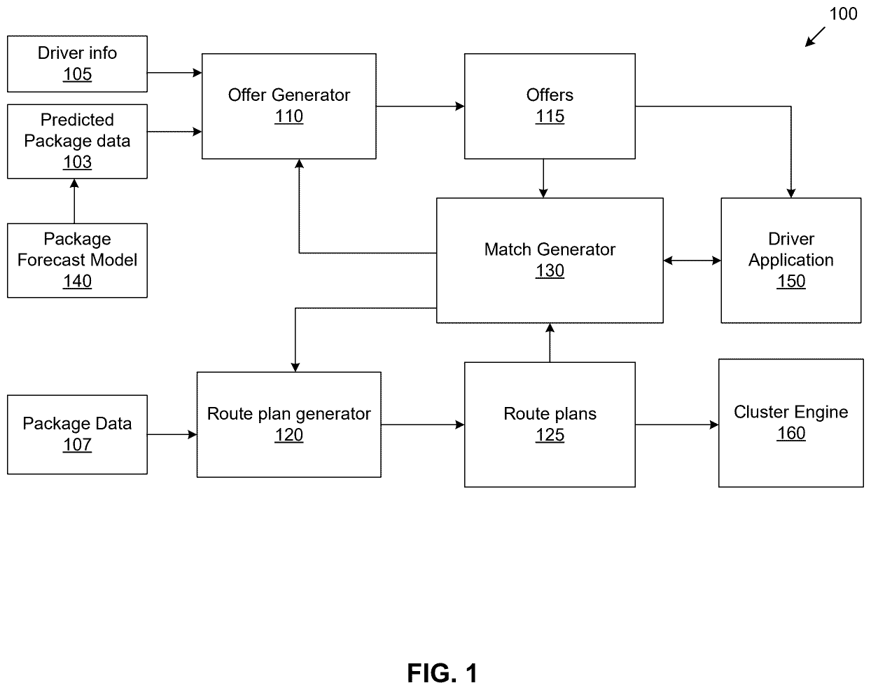

FIG. 1 is a block diagram of an example system 100 for coordinating package delivery. The system 100 includes an offer generator 110. The offer generator 110 may be a machine-learning model trained to generate offers 115. The offers 115 may be driver-facing offers to deliver packages. The offers 115 may each include one or more of a region, price, duration, and a number of packages. The region can be a predicted region, as the predicted region is based on the predicted package data. The duration can be a predicted duration, as the predicted duration is based on the predicted package data. The price can be a value representing an incentive to drivers to accept the offer to deliver packages. The offers 115 may be embodied in offer data structures that include the predicted region, the predicted duration, and the value. The data structures may be used to present the offers to the drivers. The offers can be referred to as provisioning offers, as drivers, also referred to as “provisioning agents,” deliver, or “provision,” packages to locations. In some implementations, the offers 115 each one or more of a range of potential prices, a range of potential durations, and/or a range of a potential number of packages.

The offer generator 110 may receive as input predicted package data 103 and output the offers 115. The predicted package data 103 may include a prediction of one or more of a number of packages, destinations for packages, sizes of packages, and weights of packages. The predicted package data 103 may be based on historical package data as well as additional data such as weather, seasonal trends, and economic indicators. The predicted package data 103 may include predicted package volume for a future time period, before actual package volume is known. In some implementations, the predicted package data 103 may be generated by a package forecast model 140. The package forecast model 140 may be a machine-learning model. The package forecast model 140 may be trained using historical package data and/or additional data such as weather, seasonal trends, and economic indicators to generate the predicted package data 103. In an example, the package forecast model 140 is trained using a supervised training approach in which the package forecast model 140 is executed using as input historical data to generate a predicted package volume for a time period which is compared to an actual package volume for the time period. In this example, the package forecast model 140 is updated based on a difference between the predicted package volume and the actual package volume.

In some implementations, the offer generator 110 receives as input the predicted package data 103 as well as driver information 105. The driver information 105 may include driver vehicle information, such as vehicle size, vehicle height, vehicle capacity (e.g., in cubic feet), and other vehicle characteristics. In an example, the offer generator 110 receives as input the predicted package data 103 and vehicle capacity information and generates the offers 115 based on how many packages of the predicted package data 103 can fit in driver vehicles. The driver information 105 may include a ratio of successful deliveries performed by a driver, a delivery speed of the driver, a starting location of the driver, and/or prices of offers previously accepted by the driver.

The offer generator 110 may be trained using historical data. In an example, the offer generator 110 may be executed using as input historical data to generate offers for a historical time period, which offers are compared to actual, human-generated offers for the historical time period. In this example, the offer generator 110 is updated based on a difference between the generated offers for the historical time period and the actual offers for the historical time period. In some implementations, the offer generator 110 may be trained based on an acceptance rate of the offers 115. In an example, the offer generator 110 may be trained based on a speed at which the offers 115 are accepted. In an example, the offer generator 110 may be trained based on whether the offers 115 are accepted quickly enough to ensure timely delivery of packages.

The offers 115 may be provided to drivers using a driver application 150. The driver application 150 may a computer application (e.g., mobile application) which provides a user interface for drivers to view and accept the offers 115. The driver application 150 may display the offers 115 including prices, ranges of prices, region, numbers of packages, ranges of number of packages, durations, or ranges of durations. The drivers may, using the driver application 150, accept offers for current and/or future time periods. In an example, a driver accepts, using the driver application 150, an offer to deliver packages the same day when the packages are to be delivered. In an example, a driver accepts, using the driver application 150, an offer to deliver packages three days before when the packages are to be delivered. In an example, a driver accepts, using the driver application 150, an offer to deliver packages one week before when the packages are to be delivered.

The system 100 includes a route plan generator 120. The route plan generator 120 may be a machine-learning model which is executed using as input package data 107 to generate route plans 125. The package data 107 may be actual package data including a number of packages, delivery destinations of the packages, sizes and weights of the packages, and other package characteristics. The package data 107 may be received from a variety of sources. In an example, the package data 107 may be received using API calls from a plurality of merchants which need packages delivered, the API calls ingested to produce the package data 107 as input to the route plan generator 120. The route plans 125 may be routes through a delivery region. The route plans 125 may include routes for delivery drivers to take in delivering packages. The route plans 125 may be associated with packages of the package data 107 or generated based on the package data 107 but not associated with any specific packages of the package data 107. The route plans 125 may include break points representing points in the route plans where the route plans may be broken into smaller route plans if needed. In this way, portions of route plans may be moved between different route plans, providing flexibility in how packages are to be delivered.

The route plans 125 may be referred to as “routes of provisioning tasks,” where each provisioning task involves provisioning (i.e., delivering) a package or set of packages to a location. The route plans 125 may be embodied in route plan data structures, also referred to as provisioning task data structures. The provisioning task data structures include a set of provisioning tasks that form a route of provisioning tasks.

The route plan generator 120 may receive as input the package data 107 and output the route plans 125. The route plan generator 120 may optimize the route plans 125 based on package density (e.g., density of deliveries in an area) and distance from a pickup location (e.g., distance from a warehouse where drivers pick up packages).

The route plan generator 120 may be trained to generate and optimize the route plans 125 using a supervised or semi-supervised training approach. The route plan generator 120 may be trained using historical data. In an example, the route plan generator 120 may be executed using historical data to generate route plans for a historical period which are compared to actual route plans (e.g., human-generated route plans) used for the historical period. In this example, the route plan generator 120 is updated based on a difference between the actual route plans and the generated route plans. The route plan generator 120 may be updated based on delivery statistics. In an example, the route plan generator 120 generates the route plans 125, the route plans 125 are used by drivers to deliver packages, and delivery times of the packages are used to update the route plan generator 120. In this example, the route plan generator 120 may be updated, using the delivery times of the packages, to better optimize the route plans for time between stops as well as a total delivery time for the packages.

The route plan generator 120 may begin to generate the route plans 125 once the package data 107 begins to be received. The route plan generator 120 may dynamically generate and update the route plans 125 as the package data 107 is received. The offer generator 110 may begin to generate the offers 115 before the package data 107 begins to be received. The offer generator 110 may begin to generate the offers once the predicted package data 103 is generated/received. In this way, the offers 115 may be generated before the route plans 125. The offers 115 and route plans 125 may be dynamically generated and updated until package assignments are finalized and/or until drivers pick up the packages for delivery. In this way, the offers 115 may begin to be generated before the route plans 125 begin to be generated, and the offers 115 and the route plans 125 may be dynamically generated and updated until package assignments are finalized and/or until drivers pick up the packages for delivery.

The system 100 includes a match generator 130. The match generator 130 may be a machine-learning model which is executed using as input the offers 115 and the route plans 125 to generate pairs of offers and route plans. The offer and route plan pairs generated by the match generator 130 may include an offer of the offers 115 and one or more route plans of the route plans 125. The match generator 130 may generate the offer and route plan pairs based on characteristics of the offers 115 and the route plans 125. The offer and route plan pairs may be referred to as pairings of provisioning data structures and routes of provisioning tasks. In some implementations, the match generator 130 generates a vector comprising an identifier of a provisioning data structure and an identifier of a route of provisioning tasks in order to generate the pairings of provisioning data structures and routes of provisioning tasks.

The match generator 130 may be trained to generate and optimize the offer and route plan pairs using a supervised or semi-supervised training approach. The match generator 130 may be trained using historical data. The match generator 130 may be executed using a set of offers and a set of route plans to generate predicted pairs which are compared to actual pairs of the set of offers and the set of route plans (e.g., human-generated pairs). The match generator 130 may be updated based on a difference between the predicted pairs and the actual pair. In some implementations, the match generator 130 may be trained based on delivery statistics resulting from implementation by drivers of generated offer and route plan pairs. In an example, the match generator 130 is updated using delivery times and delivery durations resulting from implementation of offer and route plan pairs generated by the match generator 130. In this way, the match generator 130 can learn from historical data and/or the consequences of its own output.

The match generator 130 may pass the offer and route plan pairs and/or the route plans 125 to the offer generator 110. The offer generator 110 may dynamically generate and update the offers 115 based on the offer and route plan pairs and/or the route plans 125. The updated offers 115 may be provided as input to the match generator 130 which dynamically generates and updates the offer and route plan pairs. In this way, the offers 115 are dynamically generated and updated in a cyclical manner. Similarly, the match generator 130 may pass the offer and route plan pairs and/or the offers 115 to the route plan generator 120. The route plan generator 120 may dynamically generate and update the route plans 125 based on the offer and route plan pairs and/or the offers 115. The updated route plans 125 may be provided as input to the match generator 130 which dynamically generates and updates the offer and route plan pairs. In this way, the route plans 125 are dynamically generated and updated in a cyclical manner.

In some implementations, the offers 115, the route plans 125, and the offer and route plan pairs are updated sequentially. In an example, the offer and route plan pairs are generated, the offers 115 are updated based on the offer and route plan pairs, the offer and route plan pairs are updated based on the offers 115, and the route plans 125 are updated based on the updated offer and route plan pairs and the updated offers 115. In some implementations, the offers 115 and the route plans 125 are updated in parallel. In an example, the offer and route plan pairs are generated, the offers 115 and the route plans 125 are each updated based on the offer and route plan pairs, the offer and route plan pairs are updated based on the updated offers 115 and updated route plans 125, and so on. In some implementations, the offers 115, the route plans 125, and the offer and route plan pairs are updated using a combination of sequential and parallel updates. In this way, the offers 115, the route plans 125, and the offer and route plan pairs are dynamically generated and updated in order to improve and optimize the offers 115, the route plans 125, and the offer and route plan pairs.

In some implementations, dynamically generating and updating the offers 115 and the route plans 125 includes generating new offers 115 and/or route plans 125. In an example, if not enough offers were initially generated for the package volume of the package data 107, additional offers can be generated. In an example, if too many offers were initially generated, one or more offers can be deleted and/or one or more route plans can be split to be mapped to different offers.

Each of the offers 115, the route plans 125, and the offer and route plan pairs may be updated as soon as they are initially generated and/or as soon as updated data is available. In an example, the offers 115 may be updated based on new predicted package data 103, new driver information 105, new/updated offer and route plan pairs, and/or new/updated route plans 125. In an example, the route plans 125 may be updated based on new package data 107, new/updated offer and route plan pairs, and/or new/updated offers 115. In an example, the offer and route plan pairs may be updated based on new/updated offers 115 and/or new/updated route plans 125.

The match generator 130 may provide the offer and route plan pairs to the driver application 150. The match generator 130 may provide the offer and route plan pairs to the driver application 150 based on driver check-in and/or drivers arriving to pick up packages. In some implementations, the match generator 130 may provide the offer and route plan pairs at a predetermined time prior to the drivers arriving to pick up packages in order to inform drivers beforehand of routes they will be driving. Providing the offer and route plan pairs to the driver application 150 may include providing the route plans 125 to the driver application 150 corresponding to offers of the offers 115 which have been accepted by drivers. In some implementations, a driver accepting an offer is referred to as a provisioning agent selecting provisioning tasks, or a provisioning data structure, for execution. In an example, providing the offer and route plan pairs to the driver application 150 includes identifying a driver who accepted an offer, identifying, using the offer and route plan pairs, a route plan corresponding to the offer, and sending the route plan to the driver application 150 to be displayed to the driver. In this way, drivers can view and accept the offers 115 before the package data 107 is received and before the route plans 125 are generated, and then deliver packages according to the route plans 125 once the route plans 125 are generated and paired with the accepted offers 115.

The route plans 125 may be delivered as input to a cluster engine 160. The cluster engine 160 may generate clusters of packages based on the route plans 125. The clusters may be used to sort packages for pickup by drivers for delivery. The cluster engine 160 may dynamically update the clusters based on updates to the route plans 125. In some implementations, the dynamic generation and updating of the route plans 125 is constrained by timing requirements of the package sorting process. In this way, the route plans 125 may be dynamically generated and updated for as long as feasible, or until packages need to be physically sorted according to the clusters. The drivers may pick up packages sorted by clusters for delivery using the corresponding route plans 125.

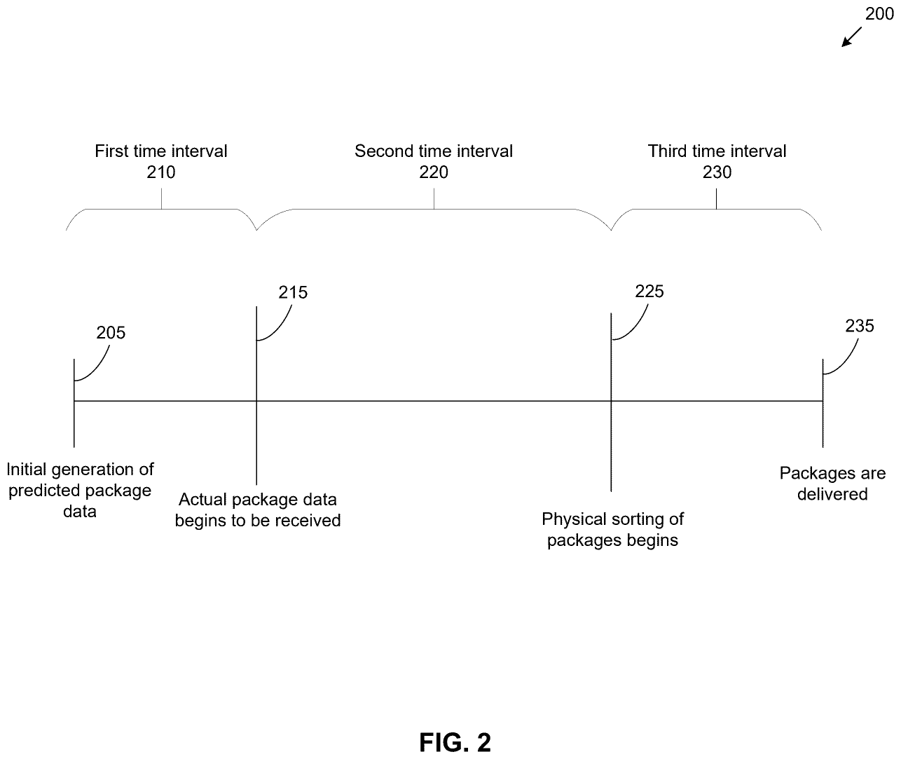

FIG. 2 is an example timeline 200 for coordinating package delivery. The timeline 200 may be a timeline of actions performed by the system 100. The timeline 200 may include a first time interval 210, a second time interval 220, and a third time interval 230. While the timeline 200 is illustrated as being linear, the timeline 200 may be circular, or cyclical. The timeline 200 is not drawn to scale and merely serves to illustrate the relative timing of operations.

The timeline 200 may be a timeline for the processing and delivery of a set of packages, a time period, or a set of packages to be delivered in a time period. In an example, the timeline 200 may represent a timeline for the coordination and delivery of a set of packages that need to be delivered on a specific day.

The first time interval 210 may begin at 205 with an initial generation of predicted package data, such as the predicted package data 103 of FIG. 1. During the first time interval 210, offers (i.e., the offers 115 of FIG. 1) begin to be dynamically generated and updated based on additional and/or updated predicted package data.

The first time interval 210 ends and the second time interval begins at 215 when actual package data starts to be received. At 215, when the actual package data, such as the package data 107 of FIG. 1, begins to be received, route plans (i.e., the route plans 125 of FIG. 1) begin to be dynamically generated and updated based at least in part on the actual package data. During the second time interval 220, offer and route plan pairs are dynamically generated and updated based on the offers and route plans, the offers are dynamically generated and updated, and the route plans are dynamically generated and updated. The second time interval 220 ends and the third time interval begins at 225 when physical sorting of packages begins. In some implementations, the second time interval ends at 225 at a predetermined time before drivers arrive to pick up packages, such as a minimum time required for physically sorting packages. The second time interval 220 may be maximized to optimize the offers, the route plans, and the offer and route plan pairs.

During the third time interval 230, the drivers deliver the packages until at 235 the packages are all delivered. In this way, the offers are dynamically generated and updated during the first time interval 210 and the second time interval 220, the route plans are dynamically generated and updated during the second time interval 220, and the offer and route plan pairs are dynamically generated and updated during the second time interval 220. The first time interval 210 and the second time interval 220 may be maximized and/or adjusted to optimize the offers, route plans, and offer and route plan pairs. In an example, the first time interval 210 begins one week before the actual package data is received and the second time interval 220 ends at four a.m. on the day when the packages need to be delivered.

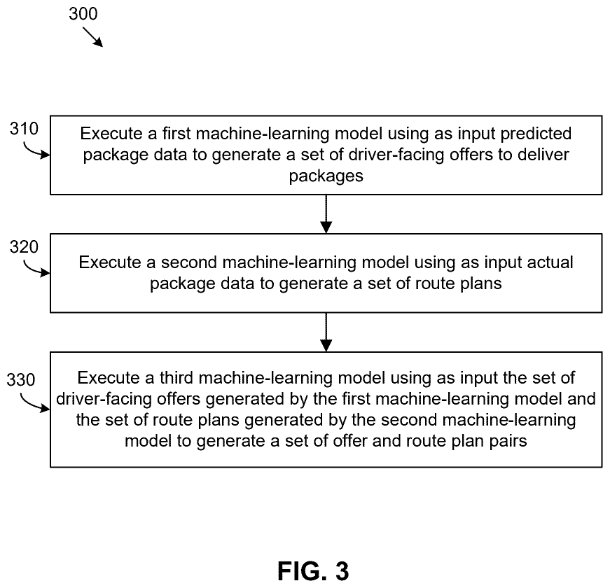

FIG. 3 is a flow diagram of an example method 300 for coordinating package delivery. The method 300 may include more, fewer, or different operations than illustrated. The operations may be performed in the order shown, a different order, or concurrently. The operations may be performed by one or more processors executing instructions included in a non-transitory, computer-readable medium, where the instructions, when executed by the one or more processors, cause the one or more processors to perform the operations of the method 300. The method 300 may be performed by the system 100 of FIG. 1.

At operation 310, a first machine-learning model is executed using as input predicted package data to generate a set of driver-facing offers to deliver packages.

At operation 320, a second machine-learning model is executed using as input actual package data to generate a set of route plans.

At operation 330, a third machine-learning model is executed using as input the set of driver-facing offers generated by the first machine-learning model and the set of route plans generated by the second machine-learning model to generate a set of offer and route pairs.

The method 300 may include providing the route plans of the set of offer and route plan pairs to one or more drivers based on the one or more drivers accepting the corresponding driving-facing offers.

In some implementations, the first machine-learning model generates the set of driver-facing offers in a first time interval, the second machine-learning model generates the set of route plans during a second time interval, and the third machine-learning model generates the set of offer and route plan pairs during the second time interval. In some implementations, the first machine-learning model dynamically updates the set of driver-facing offers during the first time interval and the second time interval. The first machine-learning model may dynamically update the set of driver-facing offers based on the set of route plans. In some implementations, the second machine-learning model dynamically updates the set of route plans during the second time interval. The second machine-learning model may dynamically update the set of route plans based on the set of driver-facing offers. In this way, the first and second machine-learning models may dynamically update the set of offers and the set of route plans, respectively based on new data, including the updates to the set of offers and the set of route plans themselves. In this way, the set of offers and the set of route plans may be optimized during the second interval. In some implementations, the third machine-learning model dynamically updates the set of offer and route pairs during the second time interval. In this way, the third machine-learning model dynamically updates the set of offer and route pairs as the set of offers and the set of route plans are updated in order to optimize the set of offer and route pairs.

The method 300 may include executing a fourth machine-learning model to generate the predicted package data. The method 300 may include executing the first machine-learning model using as input the predicted package data and driver information to generate the set of driver-facing offers. The driver information may include driver vehicle information, such as a type or size of vehicle. The driver information may include driver history, such as a ratio of successfully completed deliveries.

The method 300 may include providing packages corresponding to the route plans to drivers in response to the drivers accepting the driver-facing offers. In some implementations, once a driver accepts an offer through the driver application 150, the driver may be associated with specific packages and a corresponding route plan. The packages may then be made available to the driver for pickup and delivery. This process may involve various mechanisms for package distribution and access. For example, in some cases, packages at a centralized distribution hub may be sorted into bins or containers based on the generated route plans. When a driver arrives at the hub after accepting an offer, they may be directed to a specific bin containing the packages for their assigned route. The bin may be labeled with a unique identifier that corresponds to the driver's accepted offer or route plan. In other implementations, the system may utilize electronically controlled storage solutions to manage package access. For instance, packages may be stored in electronically locked storage lockers at pickup locations. When a driver who has accepted an offer arrives at the pickup location, they may use their mobile device running a driver application to send a request to unlock the storage locker containing the packages corresponding to their route plan. Upon verification of the driver's identity and confirmation of their accepted offer, the system may remotely unlock the specific locker containing the packages for that driver's route plan. This approach may allow for secure, contactless package pickup and may be particularly useful for decentralized distribution models or for accommodating flexible pickup times. The system may also track which packages have been picked up and by which drivers, allowing for real-time updates to route plans and offer generation as needed.

In an example, a package delivery coordination system can execute a first machine-learning model to generate driver-facing offers based on predicted package data. The predicted package data can include forecasted package volumes, estimated delivery locations, and projected package characteristics for a future time period. The first machine-learning model can analyze historical delivery patterns, seasonal trends, and economic indicators to generate the predicted package data. Based on the predicted package data, the first machine-learning model can create a set of driver-facing offers, each offer including information such as a proposed delivery region, an estimated number of packages, and a potential compensation range. The system can present these offers to drivers through a mobile application, allowing drivers to accept offers in advance of actual package data availability.

As the system begins receiving actual package data, a second machine-learning model can be executed to generate a set of route plans. The actual package data can include precise package counts, specific delivery addresses, and actual package dimensions and weights. The second machine-learning model can process the actual package data to create optimized route plans, taking into account factors such as package density in different areas, estimated travel times between delivery points, and vehicle capacity constraints. The route plans generated by the second machine-learning model can include detailed delivery sequences, estimated completion times, and potential break points where routes can be split if necessary.

Concurrently with the generation of route plans, a third machine-learning model can be executed to pair the previously generated driver-facing offers with the newly created route plans. The third machine-learning model can analyze the characteristics of both the offers and the route plans to create optimal matches. For example, the third machine-learning model can consider the estimated package counts in the offers and compare them to the actual package counts in the route plans, adjusting pairings to minimize discrepancies. The model can also take into account driver preferences, vehicle types, and historical performance data when creating the offer and route plan pairs.

Throughout the process, the system can dynamically update and refine the offers, route plans, and pairings. For instance, as more accurate package data becomes available, the first machine-learning model can adjust the driver-facing offers to better reflect the actual delivery requirements. Similarly, the second machine-learning model can continuously optimize the route plans as new packages are added or delivery conditions change. The third machine-learning model can then update the offer and route plan pairs in real-time, ensuring that the final assignments are as efficient and accurate as possible.

The system can provide significant advantages over traditional manual package delivery coordination methods. By using machine learning models to generate offers based on predicted data, the system can engage drivers earlier in the process, improving driver availability and satisfaction. The dynamic generation and updating of route plans can lead to more efficient delivery routes, potentially reducing fuel consumption and delivery times. Additionally, the automated pairing of offers and route plans can minimize human error and optimize resource allocation, resulting in improved overall delivery performance.

In some implementations, the system can incorporate real-time feedback from drivers and delivery outcomes to further refine the machine-learning models. For example, if drivers consistently complete routes faster than estimated, the second machine-learning model can adjust route planning parameters to create more ambitious delivery schedules. Similarly, if certain types of offers are frequently rejected by drivers, the first machine-learning model can adapt to generate more appealing offer structures.

The system can also provide flexibility in handling unexpected changes or disruptions. For instance, if a large number of packages are added to the system after initial route plans have been generated, the second and third machine-learning models can quickly recalculate routes and reassign packages to minimize delivery delays. This adaptive approach can help maintain efficient operations even in the face of unpredictable fluctuations in package volumes or delivery conditions.

By leveraging multiple specialized machine-learning models working in concert, the package delivery coordination system can achieve a level of optimization and efficiency that would be difficult or impossible to attain through manual methods. The system can balance the needs of drivers, package senders, and recipients while maximizing the utilization of available resources, ultimately leading to improved delivery performance and increased customer satisfaction.

In some implementations, the term “route” may be referred to as a “route of provisioning tasks.” This terminology can encompass a broader range of activities beyond traditional package delivery. A route of provisioning tasks may include a sequence of locations or actions where various services or goods are provided, such as food delivery, equipment installation, or on-site technical support.

The term “offer” may correspond to a provisioning data structure in certain aspects of the system. A provisioning data structure can include a predicted region, a predicted duration, and a value representing an incentive for a provisioning agent (e.g., driver) to accept the provisioning data structure or accept the predicted region and predicted duration for execution in exchange for the value. In some implementations, the provisioning data structure includes a vector with values for the predicted region, the predicted duration, and the value.

In some cases, a “delivery driver” may be referred to as a “provisioning agent.” This broader term can encompass individuals or entities responsible for executing the provisioning tasks along a route. Provisioning agents may include not only traditional delivery drivers but also technicians, service providers, or any personnel tasked with fulfilling the requirements of a given route. This terminology allows for a more flexible interpretation of the role, accommodating various types of service provision beyond package delivery.

In some implementations, a first machine-learning model is executed using as input predicted package data to generate a set of provisioning data structures each comprising a predicted region, a predicted duration, and a value, a second machine-learning model is executed using as input actual package data to generate a set of routes of provisioning tasks, and a third machine-learning model is executed using as input the set of provisioning data structures generated by the first machine-learning model and the set of routes of provisioning tasks generated by the second machine-learning model to generate pairings of provisioning data structures and routes of provisioning tasks.

The various illustrative logical blocks, circuits, modules, routines, and algorithm steps described in connection with the embodiments disclosed herein can be implemented as electronic hardware, or combinations of electronic hardware and computer software. To clearly illustrate this interchangeability, various illustrative components, blocks, modules, and steps have been described above generally in terms of their functionality. Whether such functionality is implemented as hardware, or as software that runs on hardware, depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A control processor can synthesize a model for an FPGA. For example, the control processor can synthesize a model for logical programmable gates to implement a tensor array and/or a pixel array. The control channel can synthesize a model to connect the tensor array and/or pixel array on an FPGA, a reconfigurable chip and/or die, and/or the like. A general purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances, where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. A system comprising:
a first machine-learning model executed using as input predicted package data to generate a set of provisioning data structures each comprising a predicted region, a predicted duration, and a value;
a second machine-learning model executed using as input actual package data to generate a set of routes of provisioning tasks; and
a third machine-learning model executed using as input the set of provisioning data structures generated by the first machine-learning model and the set of routes of provisioning tasks generated by the second machine-learning model to generate pairings of provisioning data structures and routes of provisioning tasks.

2. The system of claim 1, wherein the system provides the routes of provisioning tasks of the pairings of provisioning data structures and routes of provisioning tasks to one or more provisioning agents based on the one or more provisioning agents selecting the corresponding provisioning data structures for execution.

3. The system of claim 1, wherein the first machine-learning model generates the set of provisioning data structures in a first time interval, the second machine-learning model generates the set of routes of provisioning tasks during a second time interval, and the third machine-learning model generates the pairings of provisioning data structures and routes of provisioning tasks during the second time interval.

4. The system of claim 3, wherein the first machine-learning model dynamically updates the set of provisioning data structures during the first time interval and the second time interval.

5. The system of claim 4, wherein the first machine-learning model dynamically updates the set of provisioning data structures based on the set of routes of provisioning tasks.

6. The system of claim 3, wherein the second machine-learning model dynamically updates the set of routes of provisioning tasks during the second time interval.

7. The system of claim 6, wherein the second machine-learning model dynamically updates the set of routes of provisioning tasks based on the set of provisioning data structures.

8. The system of claim 3, wherein the third machine-learning model dynamically updates the pairings of provisioning data structures and routes of provisioning tasks during the second time interval.

9. The system of claim 1, further comprising a fourth machine-learning model to generate the predicted package data.

10. The system of claim 1, wherein the first machine-learning model is executed using as input the predicted package data and provisioning agent information to generate the set of provisioning data structures.

11. A method comprising:
executing a first machine-learning model using as input predicted package data to generate a set of provisioning data structures each comprising a predicted region, a predicted duration, and a value;
executing a second machine-learning model using as input actual package data to generate a set of routes of provisioning tasks; and
executing a third machine-learning model using as input the set of provisioning data structures generated by the first machine-learning model and the set of routes of provisioning tasks generated by the second machine-learning model to generate a pairings of provisioning data structures and routes of provisioning tasks.

12. The method of claim 11, further comprising providing the routes of provisioning tasks of the pairings of provisioning data structures and routes of provisioning tasks to one or more provisioning agents based on the one or more provisioning agents selecting the corresponding provisioning data structures for execution.

13. The method of claim 11, wherein the first machine-learning model generates the set of provisioning data structures in a first time interval, the second machine-learning model generates the set of routes of provisioning tasks during a second time interval, and the third machine-learning model generates the pairings of provisioning data structures and routes of provisioning tasks during the second time interval.

14. The method of claim 13, wherein the first machine-learning model dynamically updates the set of provisioning data structures during the first time interval and the second time interval.

15. The method of claim 14, wherein the first machine-learning model dynamically updates the set of provisioning data structures based on the set of routes of provisioning tasks.

16. The method of claim 13, wherein the second machine-learning model dynamically updates the set of routes of provisioning tasks during the second time interval.

17. The method of claim 16, wherein the second machine-learning model dynamically updates the set of routes of provisioning tasks based on the set of provisioning data structures.

18. The method of claim 13, wherein the third machine-learning model dynamically updates the pairings of provisioning data structures and routes of provisioning tasks during the second time interval.

19. The method of claim 11, further comprising executing a fourth machine-learning model to generate the predicted package data.

20. The method of claim 11, further comprising executing the first machine-learning model using as input the predicted package data and provisioning agent information to generate the set of provisioning data structures.
